(19) United States
(12) Patent Application Publication
(10) Pub. No.: US 2014/0236924 A1
(43) Pub. Date: Aug. 21, 2014

(54) Method For Improving Address Book of Mobile Means

(71) Applicant: YANDEX EUROPE AG, Luzern (CH)

(72) Inventor: Aleksandr Aleksandrovich Martynov, Tul'skaya obl. (RU)

(21) Appl. No.: 13/813,944

(22) PCT Filed: Nov. 8, 2012
(86) PCT No.: PCT/EA2012/000011

§ 371 Date: Feb. 2, 2013

(30) Foreign Application Priority Data
Nov. 8, 2011 (RU) 2011145034

(51) Int. Cl. G06F 17/30

(52) U.S. Cl. CPC G06F 17/30864
USPC 707/722

(57) ABSTRACT

The invention pertains to the functioning of a mobile communications means and it broadens the method of information search in remote databases connected to telecommunications networks, to broaden the functional capabilities of the address book. According to the proposed method, a mobile communications means is used with built-in subscriber directory, having the capability of connecting to and exchanging data via Internet with a remote server providing a search for subscriber contact data contained in a remote database. According to criteria specified by the user, a search request is performed with search for the contact data of the other subscriber both in the local address book of the mobile communications means and in the external subscriber directory base on the remote server. Based on the results of the search, the user can select the needed subscriber most fitting the criteria of the search request.

### CROSS-REFERENCE TO RELATED APPLICATIONS

This application is the United States National Stage of International Application No. PCT/EA2012/000011, filed Nov. 8, 2012, entitled “Method for Improving Address Book of Mobile Means”. Through the '011 application this application claims priority to Russian patent application no. 2011145034, filed Nov. 8, 2011. Each of these applications is incorporated by reference herein in their entirety.

### FIELD OF TECHNOLOGY

The invention pertains to methods of inserting and finding information by means of mobile communications devices, specifically, methods of finding information in databases connected to telecommunication networks, and it can substantially expand the functional capability of both mobile and stationary communications devices in finding subscriber contact numbers at the user's request.

In practically all modern mobile communications devices (such as mobile telephones) there exists an address or record book, in which the user saves telephone numbers and other information. Thus, the possibility of searching with this address book also exists. Such a search is usually accessible by means of the same interface that the user employs to dial a number and/or make calls. Alternative entry points are also possible for searching in the address book. Generally the searching in the address book is done instantly and the results are refined after each character is entered.

### PRIOR ART

One of the basic problems in the use of mobile communications means is the problem of finding and remembering the telephone numbers of subscribers. With the growth in popularity of mobile (cellular) communications, when the number of subscribers has grown many times over, this problem has become even more urgent.

There are various methods for providing the user with information on telephone numbers and the subscribers to whom these numbers belong. The traditional solution is the various telephone directories in the form of printed publications or computer programs. However, a major drawback of such means is the rapid loss of currency (obsolescence) of the published information and the need to constantly have such a directory to hand (for quick access).

The makers of modern mobile communication means, especially mobile telephones, solve this problem by building an electronic address book into the telephone. The user can enter in this address book telephone numbers of importance to him and additional information accompanying these numbers, such as last and first name of the subscriber, address, date of birth, and so on. As a result, there is no need to learn telephone numbers by heart. The user can always find them in his telephone's address book.

The drawback of this solution is that the user can make telephone calls only to those subscribers whose numbers he has previously entered in the telephone's address book or those which he remembers by heart. But if it is necessary to make a call to a subscriber whose number the user does not know (such as ordering a taxi in a strange city or reserving a table at a cafe only known by its name), then the problem arises, where to get this number and how to find it.

This problem can be solved in various ways, for example, by calling a directory service, making use of a hard copy directory, discovering the number from advertising materials, spend time searching on the Internet.

In any case, the process of discovering the needed number takes a lot of time, it is inconvenient and does not guarantee a positive outcome. Furthermore, the size of the address book of a mobile communication means is generally limited to the size of the memory of the device (such as a telephone) and a situation is possible where the memory of the address book is inadequate to record all subscriber numbers of importance to the user.

One of the closest analogues of the proposed solution is a method of entering and retrieving information about an object in a remote database (RF patent No. 2326432, IPC G06F 17/30). The known method is based on an idea analogous to the DNS (Domain Name System), the technology used on the Internet for access to sites. The inventors of the method propose entering, instead of telephone numbers, their verbal designations, or domain mobile name (DMN), as is done by Internet users who enter the alphanumeric designations (Uniform Resource Locators, or URL) instead of the numerical IP addresses of sites.

The main difference of the proposed invention is that its realization does not need the organization and supporting of any domain name systems, and consequently the user does not need to acquire additional knowledge and skills in order to exploit the advantages of the new method of finding a subscriber to make a telephone call. The user can continue making use of the mobile communications means the same as before.

Moreover, the proposed invention helps reduce the number of characters to be typed on the keypad of the device, which helps increase the speed of selecting the subscriber needed and increases the convenience of use.

The solution disclosed in patent 2326432 calls for a multistep procedure for finding the telephone number—entry of part or the full DMN name, obtaining a list of suitable names, selecting the needed DNM name from the list, obtaining the telephone on the basis of this selection and only then the call. Unlike this complex procedure, the proposed solution reduces this chain to the utmost—entry of an arbitrary word (or several words), obtaining a list of the most suitable telephone subscribers, calling the subscriber. If the needed subscriber is not on the resulting list, the request is repeated and a new list is obtained from remote databases.

Furthermore, the group of subscribers available for searching in the closest counterpart is limited only by those subscribers who have registered domain names (DMN). The proposed method does not have such limitations, since no special registration is required; it is enough to have the software and at least one remote database containing information about subscribers.

### BRIEF PRESENTATION OF THE ESSENCE OF THE INVENTION

The user of a mobile communications means with previously installed software and connection to a remote address book service makes queries by using the mobile communications means.

Analyzing the characters put in by the user, the software checks their set (sequence of characters entered) against data from the local address book and against data from a preloaded dictionary of search requests (examples of requests from the dictionary are: “beauty shop”, “restaurant”, “gas station”, “pharmacy”, “emergency room”, etc.). If there is a partial coincidence (the boundary for a partial coincidence can be flexible) between the characters entered by the user and data from the address book or from the dictionary of requests, the software forms a list of suitable subscribers and search requests. The resulting list is put out on the screen of the mobile communications means.

The user is then prompted to make the call having selected any one of the proposed subscribers, or to make a search in an external address book for one of the proposed requests, or to continue the typing of characters to refine the information needed by the user.

If the user decides to make the search in an external address book, he selects the appropriate search request (i.e., performs the same action as when selecting a subscriber to call) and the results of a search among the addresses and telephones stored in the remote database are downloaded to him from the Internet. If technically possible, the results of the search make allowance for the location of the user, and also that of the sought subscriber.

The search results can be displayed beneath the search results of the address book in the same list or they can replace it. With each search result it is possible to perform similar actions as with the addresses in the address book itself—call, look more closely, add to the local address book.

The problem of the proposed invention is to expand the functional capabilities of the address book of a mobile communications means, to solve the problem of an operative search for the telephone number of a desired subscriber and to remove the limitations of mobile communications means on the volume of information accessible to the user.

To solve the proposed problem, a method is proposed for interaction of a user's mobile communications means with the search capabilities of a network resource, such as the Internet, to ensure an integration of the local address book of the mobile communications means with remote databases containing the contact information of other subscribers, according to which:
at least one mobile communications means is used, containing a local address book having a limited number of subscriber contact data and/or memory volume for their recording, said mobile communications means having a capability of connection to and exchanging data via Internet with a remote server or other remote communications means offering a search for subscriber contact data contained in the remote database by criteria assigned by the user;
said mobile communications means is used to specify the criteria of the search request to look for the contact data of at least one subscriber, the search based on the specified search criteria being performed both in the local address book of the mobile communications means and in the external subscriber directory at the remote server;
the search is performed according to the search request, and the user can select from the search results, using the mobile communications means, the desired subscriber who most fits the criteria of the search request, to make contact with this subscriber and/or record his data in the address book of the mobile communications means and/or that of the remote server to which the user has operative access via the mobile communications means.

The mobile communications means can be a telephone or smartphone, or a pocket personal computer, or a tablet computer, or another communications means using an address book with subscriber directory.

The connection of the mobile communications means to the remote server or other remote communications means is provided by means of Internet protocols and/or cellular communications protocols and/or wireless communications (wifi) protocols and/or other protocols providing for delivery of the search criteria requested by the user to the remote server or other remote communications means and return of the search results to the mobile communications means.

The search can additionally take account of the current or specified location of the user. The search criteria are specified by means of numerical and/or alphabetic characters. The subscriber contact data can be a telephone number and/or email address and/or a unique subscriber identifier accessible in a search by Internet.

The remote server or other remote communications means provides for mutual data exchange with the user's mobile communications means.

The technical result is an improvement in the interface capabilities of the subscriber directory built into the mobile communications means, especially thanks to use of the Internet.

As a result, the user of the mobile communications means is able to establish voice connections not only with subscribers whose contact information is known to the user, and recorded in the address book, such as that of a mobile telephone or SIM card, but also with any other subscribers whose contact information is in the remote Internet resource or other remote communications means containing a remote subscriber database.

The technical result is achieved by adding to the subscriber select function of the mobile communications means the ability to establish an interaction of the mobile communications means through the Internet (or other communications network) with a remote server or other remote communications means containing a remote subscriber database in order to obtain from the remote subscriber database additional information about subscribers who are absent from the subscribers directory or address book that is built into the mobile communications means.

### DETAILED DISCLOSURE OF THE INVENTION

The proposed invention is based on the ability of all modern mobile communications means, especially mobile telephones (and a growing number of stationary ones) to work in two modes—providing voice communications and providing access to the Internet, as well as other information exchange networks.

Thus, it becomes possible to organize a working of the address book of the telephone or other mobile communications means such that part of the address book is located directly inside the telephone (in the memory of the telephone or SIM card) and part is exported to a remote database, such as one located in the Internet on a remote server.

The subscriber telephone numbers which the user himself enters into the telephone are memorized in the local part of the address book, while telephone numbers which may potentially be needed by the user (such as the numbers of local organizations and services) are situated in the remote database (on the remote server).

When the user is about to make a telephone call, he begins the process of entering the numerical subscriber number (if he remembers it), or the designation of the subscriber (such as the name of a person or the title of an organization).

At the instant of pressing a key on the keypad of the telephone or other mobile communications means the previously installed software begins to perform a search in the address book for suitable subscribers by comparing the characters already entered by the user with the available entries in the local and external (remote resource) parts.

Subscribers containing in their name or designation a sequence of characters entered by the user are put out to the telephone screen, and the user can select one of them to make the call, or continue the entry and search if the needed subscriber is not among the presented alternatives.

The layout of the search request and the fields of the request can vary.

For example, having typed on the keypad of the mobile communications means the sequence of two letters “t” and “a”, the user may receive information on the following subscribers: “Tanya”, “Tamara”, “Taxi (order”), “Tashir (food delivery)”. The information about subscribers “Tanya” and “Tamara” can be taken from the local part of the address book of the telephone, and the information on the taxi ordering and food delivery services can be found in the remote database and might be unknown to the user prior to the making of the call.

So as not to give the user the feeling of slow operation of the address book of the mobile communications means (which is possible if one is in a zone of uncertain reception of the mobile communications signal or in the case of a slow Internet connection), the most popular search requests can be preloaded (cached) in advance. In this case, the search will be done on the preloaded data (located in the memory of the telephone in the form of a dictionary of search requests), the results of the search will be put out at once to the user and along with them the option will be presented of doing a supplemental search in the remote subscriber database.

Thus, the declared invention proposes a simple method of solving the problem of an operative search for subscriber telephone numbers, including also supplemental information, such as location.

According to the proposed method of improving the functional capabilities of the subscriber directory built into a mobile communications means, to the information on subscribers entered by the user in the address book there can be added, selectively or automatically, information on new subscribers obtained from at least one server located in the Internet, at the instant of the user entering the telephone number or subscriber's name. As a result of this, telephone calls not only to subscribers whose telephone numbers are found in the address book but also to any other subscribers on whom information is available in the remote server's database become possible.

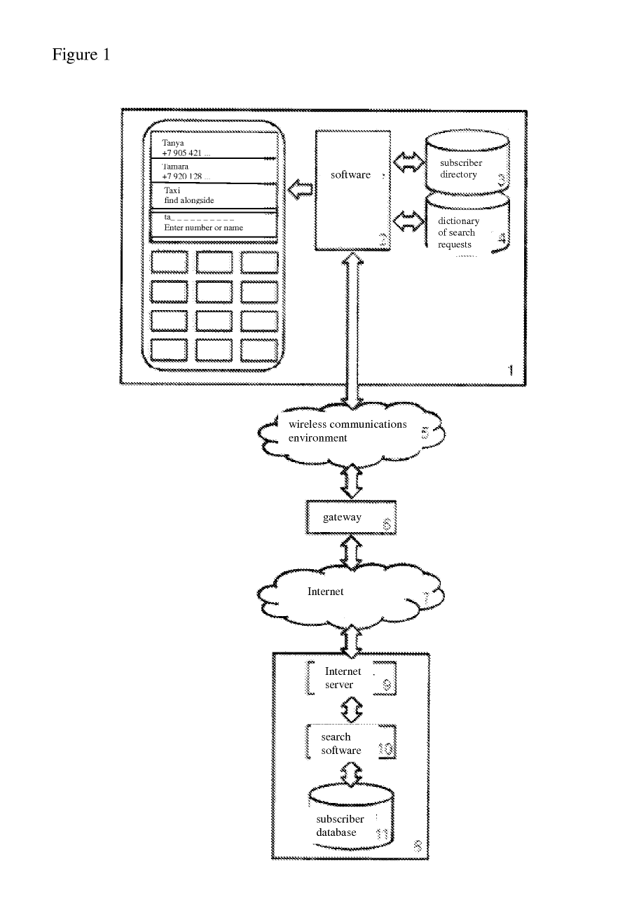

An example of the overall functional diagram of the system illustrating one embodiment of the invention is presented in FIG. 1.

FIG. 1 is an overall functional diagram of the system to implement the proposed method.

The principal components of the system implementing the proposed method are:

The mobile communications means (1), such as a telephone with software (2) provided on it, or with option of installing additional software, a local address book (3), and a dictionary of search requests (4).

Also needed to implement the method are a wireless communications environment (5), being a standard set of hardware and software built into the telephone to provide for transmission of information by wireless communications protocols (GSM, GPRS, EDGE, 3G, WiFi), a gateway (provider equipment) (6), providing access to the Internet (or other data exchange network), the Internet (7) or other network through which data is exchanged with a remote subscriber database (11), a remote server (8), being a computer or several computers joined into a network, with an Internet server (9) and installed software to process search requests (10) for data in a subscriber database (11).

The system shown in FIG. 1 functions as follows:

When it is necessary to make a telephone call, the user begins to enter the number of the subscriber being called (if he remembers the necessary number) or his first/last name or title (if he does not remember or know the necessary number), using the keypad of the mobile communications means (1). The software of the mobile communications means (2) receives the characters entered by the user and as they are being typed (whenever the user enters another character) it performs a search for subscribers containing the entered set of characters in their number or denomination. For example, after the user has entered the character “t”, the search result might be a list of subscribers with the following content: “Tanya”, “Tolya”, “Taxi”. After the second character is entered, such as “a”, the search is repeated using the two characters “ta”, as a result of which the list is shortened and will appear as follows: “Tanya”, “Taxi”. After entering the third character “n”, the search will be done on the set of characters “tan” and in the resulting list only one subscriber will remain, “Tanya”.

The example is purely arbitrary, the actual search request and its processing might have a complicated algorithm.

In any case, the search is done consecutively on two databases. First, the contents of the local address book (3) can be viewed, and then the content of the previously loaded (cached) dictionary of search requests (4), containing the names of the most requested subscribers, such as local organizations and services (examples of possible names: “taxi”, “beauty shop”, “pharmacy”, “cafe”, “emergency room”, etc.).

If certain subscribers from the local address book (3) correspond to the user's search request, the list of these subscribers will be put out to the screen of the mobile communications means. If any entry from the cached dictionary of search requests (4) corresponds to the user's search request, this entry will likewise be put out to the screen of the mobile communications means and the user will be prompted to search for a specific organization or service in the address book located in the external database on the remote server in the Internet.

The user scrutinizes the list of telephone numbers and subscriber names put out on the screen and either continues the entry process, refining the search request, or selects the needed subscriber from the presented list and makes the call, or agrees to do the search in the external database.

Having received the command from the user to search in the external database, the software (2) formulates a request to the remote subscriber database (11) and sends the request to the remote server (8) via the wireless communications channel (5), the gateway (6), and the Internet (7).

The Internet server (9) software of the remote server (8) receives the request and transmits it for processing to the software (10), which carries out the search for subscribers fitting the request in the subscriber database (11), formulates the resulting list of subscribers, and sends it to the user.

To increase the relevancy of the response, the search may consider additional parameters besides the search request, such as the current geographical location of the user (if such information and its processing are available).

The formulated search response from the remote server (8) is received via the Internet server (9), the Internet (7), the gateway (6) and the wireless communications channel (5) by the software (2) of the mobile communications means that provides for the operation of the remote address book service and is put out onto the screen of the mobile communications means in place of the previous list of subscribers or beneath it. The user scrutinizes the list put out on screen and either selects the needed subscriber from the presented list and makes the call or refines the search request if the needed subscriber was not found in the list.

Thus, the proposed method provides an operative search for a subscriber's number and lets one make calls not only with telephone numbers known to the user or previously recorded in the address book of the mobile communications means but also to subscribers whose numbers are not known to the user, and are kept in a remote database, which improves and broadens the capabilities of the address book of the mobile communications means.

1-7. (canceled)

8. A method of retrieving contact information via a client device, the method comprising:
receiving from a user of the client device via a user interface of the client device a search query to be searched in a first database resident on the client device, the first database containing contact information specific to the client device;
effecting on the client device a first search in respect of the search query in the first database, yielding first search results;
sending the search query by the client device to at least one server via a communications network;
receiving by the client device from the at least one server via the communications network second search results of a second search having been conducted in respect of the search query in at least one second database not resident on the client device in operational communication with the at least one server, the at least one second database containing contact information not specific to the user of the device; and
providing the user via the user interface of the client device with the first search results and the second search results concurrently.

9. The method of retrieving contact information of claim 8, wherein the second search results include contact information, and further comprising sending by the client device via the communications network a request to initiate a telephone call in respect of the received contact information in the second search results.

10. The method of retrieving contact information of claim 8, further comprising:
receiving from the user via the user interface of the client device a selection of one from the first search results and the second search results, and if the selection is one from the second search results, then:
sending by the client device to the at least one server via the communications network an indication of the selection;
receiving by the client device from the server via the communications network additional information regarding the selection; and
providing the user via the user interface of the client device with the additional information regarding the selection.

11. The method of retrieving contact information of claim 10, wherein the additional information includes contact information, and further comprising sending by the client device via the communications network a request to initiate a telephone call in respect of the received contact information in the additional information.

12. The method of retrieving contact information of claim 8, wherein the search query is a series of letters of an incomplete word, and further comprising:
receiving from the user via the user interface of the client device at least one additional letter of the word of the search query to define a revised search query;
effecting on the client device a third search in respect of the revised search query in the first database, yielding third search results;
sending the revised search query by the client device to the at least one server via the communications network;
receiving by the client device from the at least one server via the communications network fourth search results of a fourth search having been conducted in respect of the revised search query in the at least one second database;
providing the user via the user interface of the client device with the third search results and the fourth search results concurrently.

13. The method of retrieving contact information of claim 12, wherein the fourth search results include contact information, and further comprising sending by the client device via the communications network a request to initiate a telephone call in respect of the received contact information in the fourth search results.

14. The method of retrieving contact information of claim 12, further comprising:
receiving from the user via the user interface of the client device a selection of one from the third search results and the fourth search results, and if the selection is one from the fourth search results, then:
sending by the client device to the server via the communications network an indication of the selection;
receiving by the client device from the server via the communications network additional information regarding the selection; and
providing the user via the user interface of the client device with the additional information regarding the selection.

15. The method of retrieving contact information of claim 14, wherein the additional information includes contact information, and further comprising sending by the client device via the communications network a request to initiate a telephone call in respect of the received contact information in the additional information.

16. A method of retrieving contact information via a client device, the method comprising:
receiving by the client device from at least one server via a communications network a first database containing contact information not specific to a user of the client device;
receiving from the user of the client device via a user interface of the client device a search query to be searched in a second database resident on the client device, the second database containing contact information specific to the user of the client device;
effecting on the client device a first search in respect of the search query in the first database, yielding first search results;
effecting on the client device a second search in respect of the search query in the second database, yielding second search results;
providing the user via the user interface of the client device with the first search results and the second search results concurrently.

17. The method of retrieving contact information of claim 16, further comprising:
sending by the client device to the at least one server via the communications network the search query;
receiving by the client device from the at least one server via the communications network third search results of a third search having been conducted in respect of the search query in at least one third database not resident on the client device in operational communication with the at least one server, the third database containing contact information not specific to the user of the client device; and
providing the user via the user interface of the client device with the third search results.

18. The method of retrieving contact information of claim 17, wherein providing the user with the third search results is providing the user with the first search results, the second search results and the third search results concurrently.

19. The method of retrieving contact information of claim 16, wherein the first search results include contact information, and further comprising sending by the client device via the communications network a request to initiate a telephone call in respect of the received contact information in the first search results.

20. The method of retrieving contact information of claim 16, further comprising:
receiving from the user via the user interface of the client device a selection of one from the first search results and the second search results, and if the selection is one from the first search results, then:
sending by the client device to the at least one server via the communications network an indication of the selection;
receiving by the client device from the at least one server via the communications network additional information regarding the selection; and
providing the user via the user interface of the client device with the additional information regarding the selection.

21. The method of retrieving contact information of claim 20, wherein the additional information includes contact information, and further comprising sending via the client device via the communications network a request to initiate a telephone call in respect of the received contact information in the additional information.

22. The method of retrieving contact information of claim 16, wherein the search query is a series of letters of an incomplete word, and further comprising:
receiving from the user of the client device via the user interface of the client device at least one additional letter of the word of the search query defining a revised search query;
effecting on the client device a fourth search in respect of the revised search query in the first database, yielding fourth search results;
effecting on the client device a fifth search in respect of the revised search query in the second database, yielding fifth search results;
providing the user via the user interface of the client device with the fourth search results and the fifth search results concurrently.

23. The method of retrieving contact information of claim 22, further comprising:
sending by the client device to the at least one server via the communications network the revised search query;
receiving by the client device from the at least one server via the communications network sixth search results of a sixth search having been conducted in respect of the search query in the at least one third database not resident on the client device in operational communication with the at least one server; and
providing the user via the user interface of the client device with the sixth search results.

24. The method of retrieving contact information of claim 23, wherein providing the user with the sixth search results is providing the user with the fourth search results, the fifth search results and the sixth search results concurrently.

25. The method of retrieving contact information of claim 22, wherein the fourth search results include contact information, and further comprising sending by the client device via the communications network a request to initiate a telephone call in respect of the received contact information in the third search results.

26. The method of retrieving contact information of claim 22, further comprising:
receiving from the user via a user interface of the client device a selection of one from the fourth search results and the fifth search results, and if the selection is one from the fourth search results, then:
sending by the client device to the at least one server via the communications network an indication of the selection;
receiving by the client device from the at least one server via the communications network additional information regarding the selection; and
providing the user via the user interface of the client device with the additional information regarding the selection.

27. The method of retrieving contact information of claim 26, wherein the additional information includes contact information, and further comprising sending by the client device via the communications network a request to initiate a telephone call in respect of the received contact information in the additional information.

28. A computer usable information storage medium having computer readable program code embodied thereon for retrieving contact information via a client device, the computer readable program code including instructions that when executed by a computer processor of the client device effect:
receipt from a user of the client device via a user interface of the client device of a search query to be searched in a first database resident on the client device, the first database containing contact information specific to the user of the client device;
a first search in respect of the search query on the client device in the first database, yielding first search results;
dispatch of the search query by the client device to at least one server via a communications network;
receipt by the client device from the at least one server via the communications network of second search results of a second search having been conducted in respect of the search query in at least one second database not resident on the client device in operational communication with the at least one server, the at least one second database containing contact information not specific to the user of the client device; and
provision of the user via the user interface of the client device with the first search results and the second search results concurrently.

29. The computer usable information storage medium of claim 28, wherein the second search results include contact information, and wherein the computer readable program code further includes instructions that when executed by the computer processor effect dispatch by the client device via the communications network of a request to initiate a telephone call in respect of the received contact information in the second search results.

30. The computer usable information storage medium of claim 28, wherein the computer readable program code further includes instructions that when executed by the computer processor effect:
receipt from the user via the user interface of the client device of a selection of one from the first search results and the second search results, and if the selection is one from the second search results, then:
dispatch by the client device to the at least one server via the communications network of an indication of the selection;
receipt by the client device from the server via the communications network of additional information regarding the selection; and
provision of the user via the user interface of the client device with the additional information regarding the selection.

31. The computer usable information storage medium of claim 30, wherein the computer readable program code further includes instructions that when executed by the computer processor effect dispatch by the client device via the communications network of a request to initiate a telephone call in respect of the received contact information in the additional information.

32. The computer usable information storage medium of claim 28, wherein the search query is a series of letters of an incomplete word, and wherein the computer readable program code further includes instructions that when executed by the computer processor effect:
receipt from the user via the user interface of the client device of at least one additional letter of the word of the search query to define a revised search query;
a third search in respect of the revised search query on the client device in the first database, yielding third search results;
dispatch of the revised search query by the client device to the at least one server via the communications network;
receipt by the client device from the at least one server via the communications network of fourth search results of a fourth search having been conducted in respect of the revised search query in the at least one second database;
provision of the user via the user interface of the client device with the third search results and the fourth search results concurrently.

33. The computer usable information storage medium of claim 32, wherein the fourth search results include contact information, and wherein the computer readable program code further includes instructions that when executed by the computer processor effect dispatch by the client device via the communications network of a request to initiate a telephone call in respect of the received contact information in the fourth search results.

34. The computer usable information storage medium of claim 27, wherein the computer readable program code further includes instructions that when executed by the computer processor effect:
receipt from the user via the user interface of the client device of a selection of one from the third search results and the fourth search results, and if the selection is one from the fourth search results, then:
dispatch by the client device to the server via the communications network of an indication of the selection;
receipt by the client device from the server via the communications network of additional information regarding the selection; and
provision of the user via the user interface of the client device with the additional information regarding the selection.

35. The computer usable information storage medium of claim 34, wherein the additional information includes contact information, and wherein the computer readable program code further includes instructions that when executed by the computer processor effect dispatch by the client device via the communications network of a request to initiate a telephone call in respect of the received contact information in the additional information.

36. A computer usable information storage medium having computer readable program code embodied thereon for retrieving contact information via a client device, the computer readable program code including instructions that when executed by a computer processor of the client device effect:
receipt by the client device from at least one server via a communications network of a first database containing contact information not specific to a user of the client device;
receipt from the user of the client device via a user interface of the client device of a search query to be searched in a second database resident on the client device, the second database containing contact information specific to the user of the client device;
a first search in respect of the search query on the client device in the first database, yielding first search results;
a second search in respect of the search query on the client device in the second database, yielding second search results;
provision of the user via the user interface of the client device with the first search results and the second search results concurrently.

37. The computer usable information storage medium of claim 36, wherein the computer readable program code further includes instructions that when executed by the computer processor effect:
dispatch by the client device to the at least one server via the communications network of the search query;
receipt by the client device from the at least one server via the communications network of third search results of a third search having been conducted in respect of the search query in at least one third database not resident on the client device in operational communication with the at least one server; and
provision of the user via the user interface of the client device with the third search results.

38. The computer usable information storage medium of claim 37, wherein provision of the user with the third search results is provision of the user with the first search results, the second search results and the third search results concurrently.

39. The computer usable information storage medium of claim 36, wherein the first search results include contact information, and wherein the computer readable program code further includes instructions that when executed by the computer processor effect dispatch by the client device via the communications network of a request to initiate a telephone call in respect of the received contact information in the first search results.

40. The computer usable information storage medium of claim 36, and wherein the computer readable program code further includes instructions that when executed by the computer processor effect:
receipt from the user via the user interface of the client device of a selection of one from the first search results and the second search results, and if the selection is one from the first search results, then:
dispatch by the client device to the at least one server via the communications network of an indication of the selection;
receipt by the client device from the at least one server via the communications network of additional information regarding the selection; and
provision of the user via the user interface of the client device with the additional information regarding the selection.

41. The computer usable information storage medium of claim 40, wherein the additional information includes contact information, and wherein the computer readable program code further includes instructions that when executed by the computer processor effect dispatch via the client device via the communications network of a request to initiate a telephone call in respect of the received contact information in the additional information.

42. The computer usable information storage medium of claim 36, wherein the search query is a series of letters of an incomplete word, and wherein the computer readable program code further includes instructions that when executed by the computer processor effect:
receipt from the user of the client device via the user interface of the client device of at least one additional letter of the word of the search query defining a revised search query;
a fourth search in respect of the revised search query on the client device in the first database, yielding fourth search results;
a fifth search in respect of the revised search query on the client device in the second database, yielding fifth search results;
provision of the user via the user interface of the client device with the fourth search results and the fifth search results concurrently.

43. The computer usable information storage medium of claim 42, wherein the computer readable program code further includes instructions that when executed by the computer processor effect:
dispatch by the client device to the at least one server via the communications network of the revised search query;
receipt by the client device from the at least one server via the communications network of sixth search results of a sixth search having been conducted in respect of the search query in the at least one third database not resident on the client device in operational communication with the at least one server; and
provision of the user via the user interface of the client device with the sixth search results.

44. The computer usable information storage medium of claim 43, wherein provision of the user with the sixth search results is provision of the user with the fourth search results, the fifth search results and the sixth search results concurrently.

45. The computer usable information storage medium of claim 42, wherein the third search results include contact information, and wherein the computer readable program code further includes instructions that when executed by the computer processor effect dispatch by the client device via the communications network of a request to initiate a telephone call in respect of the received contact information in the third search results.

46. The computer usable information storage medium of claim 42, wherein the computer readable program code further includes instructions that when executed by the computer processor effect:
receipt from the user via a user interface of the client device of a selection of one from the fourth search results and the fifth search results, and if the selection is one from the fourth search results, then:
dispatch by the client device to the at least one server via the communications network of an indication of the selection;
receipt by the client device from the at least one server via the communications network of additional information regarding the selection; and
provision of the user via the user interface of the client device with the additional information regarding the selection.

47. The computer usable information storage medium of claim 46, wherein the additional information includes contact information, and wherein the computer readable program code further includes instructions that when executed by the computer processor effect dispatch by the client device via the communications network of a request to initiate a telephone call in respect of the received contact information in the additional information.
